(19) United States
(12) Patent Application Publication
(10) Pub. No.: US 2018/0365876 A1
(43) Pub. Date: Dec. 20, 2018

(54) METHOD, APPARATUS AND SYSTEM FOR SPINE LABELING

(71) Applicants: AGFA HEALTHCARE, Vienna (AT); VRVIS ZENTRUM FÜR VIRTUAL REALITY UND VISUALISIERUNG, Vienna (AT); AVL LIST, Graz (AT)

(72) Inventors: Maria WIMMER, Mortsel (BE); David MAJOR, Mortsel (BE); Alexey NOVIKOV, Mortsel (BE); Katja BUEHLER, Mortsel (BE)

(21) Appl. No.: 15/736,860

(22) PCT Filed: Jun. 17, 2016
(86) PCT No.: PCT/EP2016/064012

§ 371 Date: Dec. 15, 2017

(30) Foreign Application Priority Data
Jun. 18, 2015 (EP) 15172692.4

(51) Int. Cl. G06T 11/60; G06T 11/00; G06T 7/73

(52) U.S. Cl. CPC G06T 11/60; G06T 11/001; G06T 2207/30012; G06T 2207/10088; G06T 2207/20081; G06T 7/75

(57) ABSTRACT

A method, an apparatus, and a system for labeling one or more parts of a spine in at least one magnetic resonance image of a human or animal body, includes transforming the image having a first number of intensity levels into a target image having a second number of intensity levels, the second number of intensity levels being smaller than the first number of intensity levels, preferably by considering the entropy of texture variations in one or more training images; determining a position, in particular a center position, in each of the one or more parts of the spine in the target image; and labeling the determined position of the one or more parts of the spine in the image or the target image with anatomical labels.

### CROSS REFERENCE TO RELATED APPLICATIONS

This application is a 371 National Stage Application of PCT/EP2016/064012, filed Jun. 17, 2016. This application claims the benefit of European Application No. 15172692.4, filed Jun. 18, 2015, which is incorporated by reference herein in its entirety.

### BACKGROUND OF THE INVENTION

### 1. Field of the Invention

The present invention relates to a method and a corresponding apparatus and system for labeling one or more parts of a spine in at least one magnetic resonance (MR) image of a human or animal body according to the independent claims.

### 2. Description of the Related Art

Labeling of the spinal column in MR sequences is an important task in clinical practice, as it serves the diagnosis and operation planning of spine related pathologies. However, when it is done manually, it is a time consuming task for clinicians, hence automatic or semi-automatic approaches are in demand. Automatic approaches do not need any user interaction, whereby semi-automatic methods rely on minimal input from the user, e.g. an initial click position. Furthermore, there is a wide range of different MR acquisition protocols which have high variations in terms of appearance and exhibit no standardized intensity scale, like the Hounsfield scale for computer tomography (CT). Therefore, approaches which are able to localize the spinal parts without retraining for the different imaging parameters are of high interest.

### SUMMARY OF THE INVENTION

Preferred embodiments of the invention provide a method, apparatus and system allowing for a reliable labeling of one or more parts of a spine in different kinds of MR image data sets, in particular without prior knowledge of respective imaging parameters.

These advantages and benefits are achieved by the method, apparatus and system described below.

A method for labeling one or more parts of a spine in at least one magnetic resonance (MR) image of a human or animal body according to an aspect of the invention comprises the following steps: transforming the image having a first number of intensity levels into a target image having a second number of intensity levels, the second number of intensity levels being smaller than the first number of intensity levels, preferably by considering the entropy of texture variations in one or more training images; determining a position, in particular a center position, in each of the one or more parts of the spine in the target image; and labeling the determined position of the one or more parts of the spine in the image or the target image with anatomical labels.

A method for labeling one or more parts of a spine in at least one magnetic resonance image of a human or animal body according to another aspect of the invention comprises the following steps:
a) transforming the image having a first number of intensity levels into a target image having a second number of intensity levels, the second number of intensity levels being smaller than the first number of intensity levels, by applying a texture transformation to the image, the texture transformation being obtained by matching a local model of the one or more parts of the spine to the spine in the image, the at least one local model being obtained by annotating training images showing one or more parts of a spine, extracting landmarks from the annotated training images and building the local model based on the extracted landmarks,
b) determining a position in each of the one or more parts of the spine in the target image, the position in each of the one or more parts of the spine in the target image corresponding to a position in the at least one local model of the one or more parts of the spine, and
c) labeling the determined position of the one or more parts of the spine in the image or the target image with anatomical labels.

An apparatus for labeling one or more parts of a spine in at least one magnetic resonance (MR) image of a human or animal body according to another aspect of the invention comprises an image processing unit configured to: transform the image having a first number of intensity levels into a target image having a second number of intensity levels, the second number of intensity levels being smaller than the first number of intensity levels, preferably by considering the entropy of texture variations in one or more training images; determine a position, in particular a center position, in each of the one or more parts of the spine in the target image; and label the determined position of the one or more parts of the spine in the image or the target image with anatomical labels.

An apparatus for labeling one or more parts of a spine in at least one magnetic resonance image of a human or animal body according to yet another aspect of the invention comprises an image processing unit configured to
a) transform the image having a first number of intensity levels into a target image having a second number of intensity levels, the second number of intensity levels being smaller than the first number of intensity levels, by applying a texture transformation to the image, the texture transformation being obtained by matching a local model of the one or more parts of the spine to the spine in the image, the at least one local model being obtained by annotating training images showing one or more parts of a spine, extracting landmarks from the annotated training images and building the local model based on the extracted landmarks,
b) determine a position in each of the one or more parts of the spine in the target image, the position in each of the one or more parts of the spine in the target image corresponding to a position in the at least one local model of the one or more parts of the spine, and
c) label the determined position of the one or more parts of the spine in the image or the target image with anatomical labels.

A system for magnetic resonance imaging and spine labeling according to yet another aspect of the invention comprises a magnetic resonance imaging (MRI) apparatus configured to acquire at least one magnetic resonance (MR) image of at least a part of a human or animal body, and an apparatus for labeling one or more parts of a spine in the at least one magnetic resonance image according to an aspect of the invention.

Preferably, the image processing and/or labeling steps of the method according to an aspect of the invention are performed automatically, i.e. without user input or interaction. Same applies to according steps performed by the apparatus according to an aspect the invention. Notwithstanding this, another aspect of the invention also relates to “semi-automatic” spine labeling, wherein a limited or minimal user input may be required. For example, a user may be required to manually select an initial position, e.g. in an intervertebral disc, in an acquired MR image to be labeled and/or to assign a single anatomical label to an initial position, e.g. a label denoting the intervertebral disc, like “L2/L3” denoting the disc between the second and third lumbar vertebra. Preferably, such user input is required before a trained model is initialized, i.e. initially placed, on one or more views of the acquired MR image and/or before the MR image is transformed to the target image having a reduced grayscale.

In particular, yet another aspect of the invention relates to a preferably semi-automatic algorithm for labeling the spinal column. In a learning-based approach, so-called entropy-optimized texture models (ETMs) of spinal parts, like intervertebral discs and vertebrae, are trained on the basis of training images and used for transforming an unseen MR image to be labeled into a target image by reducing the intensity scale of the MR image. When labeling the image, the learned models are applied and disc center positions are preferably detected with a, preferably adaptive, non-machine-learning based approach in the transformed target image.

By means of the invention, the following advantages are achieved: Various kinds of MR data, like T1-weighted (T1w) and T2-weighted (T2w) scans, acquired on different scanners with varying scan parameters, can be processed. Prior knowledge about the scan, e.g. through Digital Imaging and Communications in Medicine (DICOM) tags, is not required, because only raw image data is processed. Discs can be localized correctly in these scans after providing a disc center candidate position which lies inside the disc. The invention can be applied to sequences and protocols which are not covered by the particular training set.

In summary, the invention allows for a reliable labeling of one or more parts of a spine in different kinds of MR image data sets, in particular MR scans with high intensity variability, without prior knowledge of respective imaging parameters.

In the context of the invention, the term “part of a spine” preferably relates to a vertebra and/or an intervertebral disk of a spine. Accordingly, said one or more parts of the spine in the image correspond to one or more vertebrae and/or one or more intervertebral discs of the spine in the image.

Moreover, the term “number of intensity levels” preferably relates to the total number of different intensity values and/or grayscale values the pixels or voxels of an acquired image and/or target image have.

The term “reducing” in the context of intensity or grayscale relates to “transforming” or a “transformation of” an image by reducing its first number of intensity levels to the (smaller) second number of intensity levels. Likewise, the term “normalizing” or “normalization” preferably may also relate to a transformation of the image by reducing its number of intensity levels.

Moreover, in the context of the invention, the term “texture” or “image texture” preferably relates to information about the spatial arrangement of grayscale values and/or intensity values in an image or in a selected region of an image.

Further, in the context of the invention, the term “entropy” preferably relates to information content of an image considering a probability, in particular a probability density distribution, of the occurrence of an intensity value and/or a grayscale value.

Accordingly, considering “the entropy of texture variations in one or more training images” preferably relates to considering the probability, in particular the probability density distribution, of the occurrence of intensity values and/or grayscale values of a spatial arrangement of intensity values or grayscale values, respectively, in training images.

The term “one or more training images” preferably relates to a set of, e.g. 10 to 30, images which were acquired, preferably prior to the acquired image to be labeled, from one or more different subjects and/or by one or more different MR scanners and/or with one or more different MRI protocols.

According to a preferred embodiment, the image is transformed into the target image by applying a texture transformation to the image, wherein the texture transformation is obtained by optimizing transformations of training textures extracted from the training images having the first number of intensity levels into target textures having the second number of intensity levels in terms of entropy.

According to another preferred embodiment, the texture transformation applied to the image corresponding to a transformation of training textures of the training images having the first number of intensity levels into target textures having the second number of intensity levels. Preferably, the transformation of the training textures is optimized in terms of a probability of the occurrence of intensity values of the training textures. Preferably, the texture transformation applied to the image is further optimized by matching a local model of the one or more parts of the spine to the spine in the image, wherein the texture transformation for a currently overlapped texture is optimized with Bayesian reasoning.

Preferably, the texture transformations of the training textures are optimized iteratively based on an entropy-driven cost function.

Alternatively or additionally, the texture transformation, which is applied to the image, corresponds to a transformation of the training textures for which an entropy-driven cost function is maximal. Preferably, the transformation of training textures, for which the entropy-driven cost function is maximal, is determined iteratively.

It is, moreover, preferred that the position in each of the one or more parts of the spine in the target image is determined by considering at least one local model of the one or more parts of the spine.

Preferably, the at least one local model is a three-disc model of a section of the spine including a middle disc and its adjacent upper disc and lower disc.

It is further preferred that the at least one local model is built from sparse landmarks.

According to yet another preferred embodiment, the at least one local model is obtained in a training phase by manually annotating training images, automatically extracting sparse landmarks from the annotated training images and building the local model based on the extracted landmarks.

Preferably, the position in each of the one or more parts of the spine in the target image is determined by a, preferably adaptive, refinement of a candidate position, which is obtained by an iterative matching of the local model to the spine in the image.

Preferably, the determined position is a center position in each of the one or more parts of the spine in the target image.

Preferably, the position in each of the one or more parts of the spine in the target image is a refined position determined by a refinement of a candidate position inside the part of the spine, the refinement of the candidate position including the following steps:
spanning a bounding box around the candidate position,
deriving a surface normal describing the orientation of the part of the spine in the space,
deciding for every voxel inside the bounding box, whether the voxel belongs to the part of the spine or not, by
placing a middle filter region at the candidate position,
placing an upper filter region and a lower filter region in the target image by displacing the upper filter region and lower filter region from the middle filter region by an average thickness of the part of the spine along the surface normal,
determining the most occurring intensity value m_{M}, mᵤ and m_{L} for every region,
setting the current voxel in a binary mask, if mᵤ≠m_{M} and m_{L}≠m_{M},
calculating a centroid of the part of the spine as the refined position from the binary mask of the part of the spine.

Further advantages, features and examples of the present invention will be apparent from the following description of following figures:

### BRIEF DESCRIPTION OF THE DRAWINGS

FIG. 1 shows an example of an apparatus and a system according to the invention.

FIG. 2 shows an overview on an example of a procedure for training models for image data normalization.

FIG. 3 shows an example of a training image with extracted landmarks used for building a three-disc model.

FIG. 4 shows an overview on an example of a procedure for labeling an unseen MR image.

FIG. 5 shows a detail of an example of a normalized target image in which filter regions are marked to illustrate disc center refinement.

### DETAILED DESCRIPTION OF THE PREFERRED EMBODIMENTS

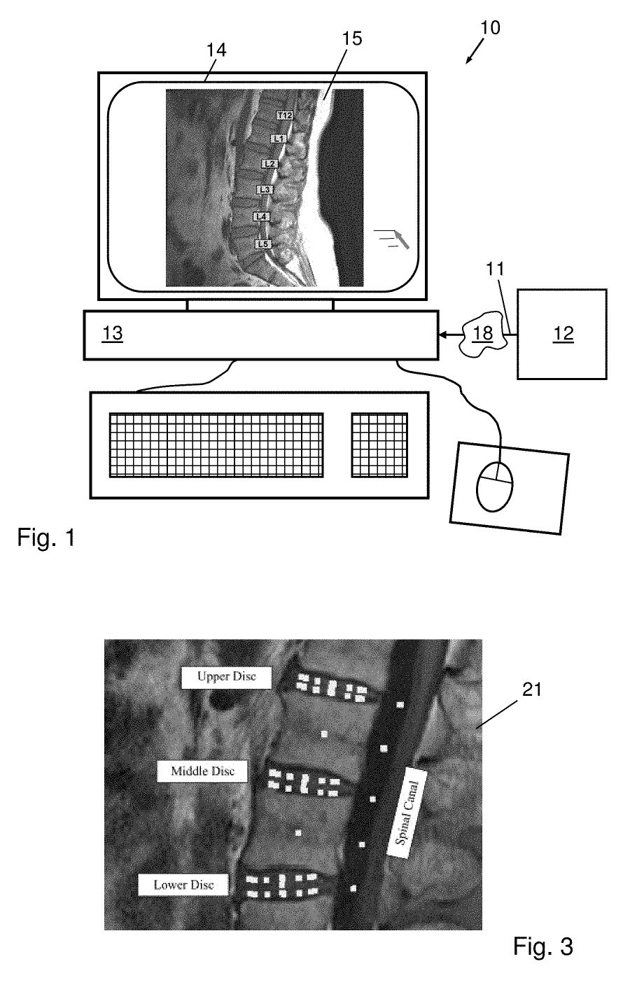

FIG. 1 shows an example of an apparatus 10 and a system according to the invention. The system comprises a medical imaging apparatus 12, in particular a magnetic resonance imaging (MRI) apparatus, which is configured to acquire one or more images, e.g. a plurality of two-dimensional images or a three-dimensional image, of a human or animal body and to generate a corresponding medical image data set 11. The apparatus 10 comprises an image processing unit 13, e.g. a workstation or a personal computer (PC), which is configured to process the image data set 11. Preferably, the image data set 11 is transferred from the medical imaging apparatus 12 to the image processing unit 13 via a data network 18, e.g. a local area network (LAN) or wireless LAN (WLAN) in a hospital environment or the internet.

The image processing unit 13 is preferably configured to generate a volume reconstruction and/or a slice image 15 of the image data set 11 on a display 14, e.g. a TFT screen of the workstation or PC, respectively. The image processing unit 13 is further configured to automatically or at least semi-automatically label one or more parts of a spine represented in the image 15. In the present example, thoracic vertebra T12 and lumbar vertebrae L1 to L5 were automatically labelled with corresponding labels “T12” and “L1” to “L5”, respectively.

According to a preferred aspect of the invention, a learning-based algorithm is applied that uses local entropy-optimized texture models for reducing, also referred to as “normalizing”, the intensity scale of the acquired image 15 to only a few gray levels of a target image. For example, the image 15 is transformed to a target image (not shown) having an intensity scale of in total three different intensity values. The task of intervertebral disc detection is performed on the normalized target image. This will be elucidated in more detail as follows.

Preferably, local entropy-optimized texture models (ETMs) are used for reducing the intensity scale of the acquired images to only a few intensity levels or gray levels of the target images. By this means, spine labeling of multi-modal imaging data, like different MR sequences and computed tomography (CT) datasets, with only a single model is enabled and/or facilitated. In the following, both the general approach of ETMs and the particular application of ETMs for spine labeling are described.

### ETMs in General

ETMs are similar to Active Appearance Models (AAMs) in the description of shape with Principal Component Analysis (PCA). From a set of annotated images with corresponding landmarks, n training textures Tₖ are extracted and quantized to r gray levels.

For the representation of texture, the intensities in the training textures Tₖ are reduced from r input gray levels, in the context of the invention also referred to as “first number of intensity levels”, to a reduced scale of only a few target gray levels s, in the context of the invention also referred to as “second number of intensity levels”. Formally, mappings fₖ for every training texture Tₖ are determined:

fₖ: [symbol] ᵣ→ [symbol] ₛ, s<<r, k=1 . . . n, (1)

Every texel tⱼ in the model texture T_{model} captures the variability of the mapped target values gᵢ^{f}∈{1 . . . 8} at the corresponding texel tⱼ in the textures Tₖ. Hence n occurrences of the possible s target values can be observed, which are interpreted as probability density functions (PDFs) pⱼ. Preferably, reliable predictions are favored over uncertain predictions by minimizing the entropy of a corresponding PDF pⱼ:

$$H ( {p}_{j} ) = - {\sum }_{i = 1}^{s} {p}_{j} ( {g}_{i}^{′} ) {log}_{2} ( {p}_{j} ( {g}_{i}^{′} ) ) \qquad ( 2 )$$

In order to increase the reliability of mappings, the entropy H^{model} for all N model texels tⱼ is minimized:

$${H}^{model} = \frac{1}{N} {\sum }_{j = 1}^{N} H ( {p}_{j} ) \to min \qquad ( 3 )$$

At the same time, the information gained from the extracted training textures Tₖ is maximized. The image entropy H^{tex} is denoted as

$${H}^{tex} = \frac{1}{n} {\sum }_{k = 1}^{n} H ( {f}_{k} ( {I}_{k} ) ) \to max . \qquad ( 4 )$$

Combining both criteria results in the final cost function:

$$\{ {f}_{1}^{*} , … , {f}_{n}^{*} \} = {argmax}_{\{ {f}_{1} , … , {f}_{n} \}} ( {H}^{tex} - {H}^{model} ) \qquad ( 5 )$$

Preferably, the texture transformations fₖ are optimized in an iterative manner. The result of the training is a learned model, which captures the uncertainty of the training textures Tₖ. Different structures are mapped to different target gray levels s depending on their contrast to each other.

Further details regarding the principle of operation of ETMs, ETM construction and ETM matching are described in S. Zambal, K. Bühler, and J. Hladůvka, Entropy-optimized Texture Models, in Medical Image Computing and Computer-Assisted Intervention—MICCAI 2008, volume 5242 of Lecture Notes in Computer Science, pages 213-221, Springer Berlin Heidelberg, 2008, which is incorporated by reference herewith.

### ETMs for Spine Labeling

In the training phase, preferably three-dimensional ETMs are learned for data normalization from a mixed set of annotated T1w and T2w MR volume datasets.

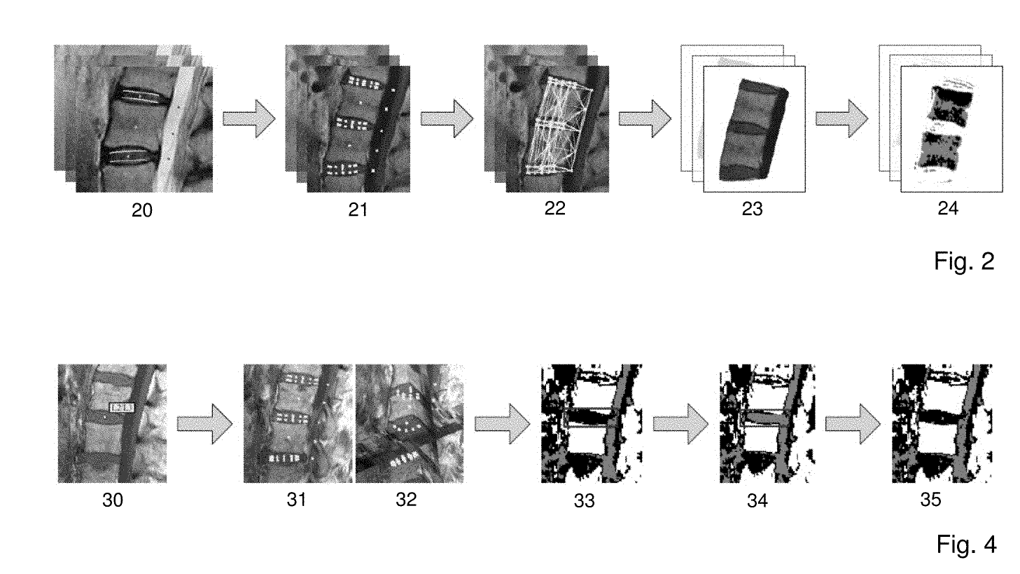

An overview of a preferred procedure for training of ETMs for data normalization is illustrated in FIG. 2. From an annotated set of Magnetic Resonance (MR) data 20, e.g. annotated T1w and T2w MR data, corresponding landmarks are extracted, see dataset 21, and a shape model is built, indicated in dataset 22. Training textures 23 are extracted and texture transformations are performed and optimized iteratively based on an entropy-driven cost function to obtain normalized training textures 24 having a reduced intensity scale. This procedure will be explained in more detail in the following.

Instead of building a single model for the complete lumbar spine, preferably a number of smaller local models are built. In this way, a higher flexibility of the method with respect to anatomical changes, e.g. in the curvature, is achieved.

Moreover, instead of building models from dense landmarks, preferably three-disc-models Mᵢ, wherein around a middle disc dᵢ also its adjacent upper disc dᵢ₋₁ and lower disc dᵢ₊₁ are included, are trained from sparse landmarks (see bright dots in three adjacent discs shown in dataset 21). Preferably, this is done for all three-disc-groups from a standard spine atlas, which consists of 24 vertebrae and 23 intermediate discs. This results in 21 local ETMs. In this way, the complete spinal region from C2/C3 to L5/S1 is covered.

Preferably, when annotating the acquired training dataset 20 one or more of the following anatomical landmarks and structures are placed in the dataset 20 by a domain expert and further used for model building:
vertebral body center positions vⱼ (see bright dot in the center of the vertebra shown) with their corresponding anatomical label kⱼ, kⱼ={C3, C4, . . . , L4, L5},
disc center positions dᵢ (see bright dots in the center of the two discs shown) with their corresponding anatomical label λᵢ, whereby λᵢ={C2/C3, C3/C4, . . . , L4/L5, L5/S1},
a cylinder, which is placed for every disc at the annotated center dᵢ in a way that it approximates the dimension of the disc and lies within the disc (see lines in each of the discs shown),
corresponding spinal canal landmarks cᵢ and cⱼ (see dark dots) to the disc and vertebrae centers are placed in the spinal canal.

For example, a total number of eight scans are used for the training of the 21 three-disc-models, wherein this set of training volumes consists of scans based on different scan parameters and/or weighting, e.g. T1w and T2w weighted scans. Hence, preferably only one cross-modality model is trained for the desired region, rather than training a model for each T1w and T2w weighting.

From the annotated ground truth, i.e. the annotated landmarks and structures in the training dataset 20, one or more of the following correspondent landmarks are extracted for model building, as illustrated by dataset 21 in FIG. 2 and FIG. 3 (see bright dots): two vertebral body center positions vⱼ, center positions of middle dᵢ, upper dᵢ₋₁ and lower disc dᵢ₊₁, and sampled points along the surface of the annotated cylinder. Furthermore spinal canal landmarks c are added, which correspond to the disc and vertebra centers. In the example given in FIGS. 2 and 3, the extracted landmarks are used for building a three-disc-model Mᵢ for the L2/L3 vertebrae. It has to be noted that all extracted 3D positions are projected to the middle sagittal slice for visualization purposes, hence some landmarks are occluded.

Further, the extracted landmarks undergo a meshing procedure, wherein a shape model, also referred to as “mesh”, of the spinal parts represented in the training image dataset is automatically generated based the extracted data, preferably by using tetrahedral elements (Delaunay Tetrahedralization), as illustrated in dataset 22 shown FIG. 2.

On the tetrahedralized meshes, training textures Tₖ 23 are extracted and optimized iteratively based on an entropy-driven cost function, so that normalized training textures 24 are obtained having a considerably smaller gray scale, e.g. 3 gray levels, than the extracted training textures 23.

For example, all extracted training textures are quantized to r=110 source gray levels and the model is trained to reduce their intensity scale to s=3 target levels. Moreover, the data are preferably resampled so that they exhibit similar voxel sizes.

The training texture intensity transformations are optimized individually for every training texture. If these intensity transformations, after the learning step, are applied to textures extracted from an (unseen) image to be labeled, a normalized representation of the textures of the image is obtained, wherein the total number of gray levels is considerably reduced, e.g. to 3 target levels.

### Labeling of an Unseen Volume Dataset

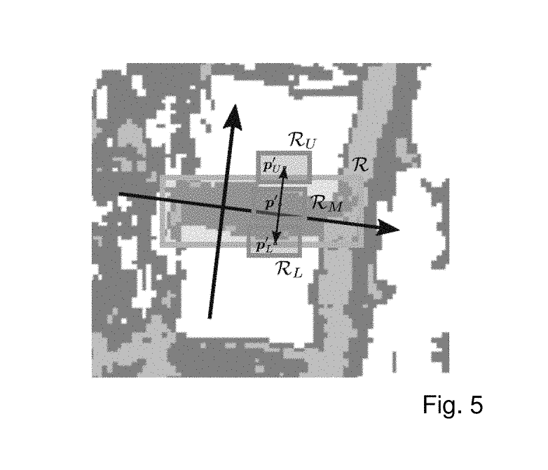

An overview on steps of a preferred procedure for labeling an unseen MR scan is illustrated in FIG. 4. Based on an initial position and label provided by a user, see bright dot and “L2/L3” in dataset 30, the corresponding model is placed in the scans, see dataset 31 (2D view) and dataset 32 (3D view). The overlapped texture is extracted and the texture transformation is optimized iteratively to obtain normalized data 33 having a reduced gray scale. On the obtained intensity-reduced scan 33, the disc candidate position d′ᵢ is refined with a, preferably adaptive, feature detector, which provides the final center position d*ᵢ, see data set 35. This procedure will be explained in more detail in the following.

In the present example, the procedure of labeling an unseen scan Iᵤ (see dataset 30 in FIG. 4) is semi-automatic, wherein minimal input from a user is required, namely:
initial click position p in the volume dataset inside an intervertebral disc or vertebra, and
anatomical label λᵢ, in present example “L2/L3”, which corresponds to the disc at the position p.

Subsequently, matching of the ETMs is performed, wherein, based on the users' clicked position p, an instance of the learned model Mᵢ, which corresponds to the user-assigned anatomical label λᵢ, is placed in the image, see datasets 31 and 32.

Then, the texture Tᵤ is extracted from the scan Iᵤ, which is currently overlapped by the learned model Mᵢ, and quantized to a first number r of source gray levels, wherein the first number r of source gray levels corresponds to the number of source gray levels learned for model Mᵢ. During iterative model matching, the texture transformation fᵤ for the currently overlapped texture Tᵤ is optimized with Bayesian reasoning.

By applying the obtained transformation fᵤ on the extracted Texture Tᵤ an intensity-reduced scan 33 (also referred to as “normalized data”) is obtained, which exhibits only a second number s of target gray levels.

Furthermore, candidate positions for the landmarks are obtained, e.g. the middle disc d′ᵢ, upper disc d′_{i 1}, lower disc d′ᵢ₊₁ or vertebrae center.

Subsequently, a refinement step, which is also referred to as adaptive disc center position refinement, is applied to the candidate disc center position d′ᵢ. Preferably, a bounding box R, which defines a region of interest for the refinement, is spanned around the model-matched disc position d′ᵢ. The size of the bounding box R is based on the annotated ground truth cylinders, from which the average dimension of discs in sagittal, axial and coronal direction is calculated: s_{sag}, sₐₓ and s_{cor}.

From the landmark positions from the matched model instance, the normal n is derived, which describes the orientation of the current disc d′ᵢ in 3D. For every voxel inside R it is decided if it belongs to the disc or not, preferably with a, preferably adaptive, method inspired by Haar-like features as described by S.-K. Pavani, D. Delgado, and A. F. Frangi, Haar-like features with optimally weighted rectangles for rapid object detection, in: Pattern Recognition, 43(1):160-172, 2010, which is incorporated by reference herewith.

FIG. 5 illustrates the approach, which works as follows:
A filter is constructed with three regions, each having the dimension sₓ×s_{y}×s_{z}: upper region R_{U}, middle region R_{M} and lower region R_{L}.
The regions are then placed in the following way: R_{M} is placed at the current position p′ in R. R_{U} and R_{L} are displaced based on the surface normal n and the average disc thickness t estimated from the ground truth data:

p′^{U}=p′+n*t̅ᵢ (6)

p′^{U}=p′−n*t̅ᵢ (7)
For every region R_{U}, R_{M} and R_{L}, the most occurring intensity value—also referred to as intensity mode—is determined: m_{L}, m_{M} and m_{U}.
The voxel in R is considered as disc candidate and the corresponding voxel is set in a binary mask at the following condition:

$$M ( x , y , z ) = \{ \begin{matrix}1 & if {\hat{m}}_{U} \neq {\hat{m}}_{M} {\hat{m}}_{L} \neq {\hat{m}}_{M} \\ 0 & otherwise \end{matrix} \qquad ( 8 )$$

From the obtained binary mask for the disc, the centroid as the refined center position d*i is calculated.

In FIG. 5 the filter regions R_{U}, R_{M} and R_{L} are represented by smaller boxes and the search region R is represented by the larger box. Note that the illustration is done in 2D for visualization purposes.

Preferably, the labeling is performed in an iterative manner. From the model matched around the initial position p candidate positions for the upper and lower disc, i.e. d′ᵢ₋₁ and d′ᵢ₊₁ are also obtained. Preferably, the search downwards the spinal column is continued towards L5/S1 and then upwards to C2/C3 and the following is done for every disc:
matching an instance of the corresponding model Mᵢ to the current underlying data and obtain a disc center position d′ᵢ from the matched model,
applying the texture transformation tᵤ, which is optimized during the model matching with Bayesian Reasoning, in order to obtain the normalized target image 33 (FIG. 4)
refining d′ᵢ with the, preferably adaptive, Haar-like disc detection method and retrieve the refined disc center d*ᵢ,
obtaining the position for the next disc from the model: d′ᵢ₋₁ resp. d′ᵢ₊₁

With this method, a point cloud for the disc is obtained, as illustrated by the bright region within the bounding box R represented in dataset 34 of FIG. 4. From the point cloud the centroid is calculated as the refined disc center position d*ᵢ.

Preferably, the search is stopped when the border of the volume is reached and/or no more refined positions are detected and/or no further trained models Mᵢ are available for matching.

A particular advantage of above aspects of the learning-based approach for semi-automatic labeling of lumbar MR volumes lies in the generality of this method by which various imaging protocols can be processed and which can be applied also to unseen protocols, which were not covered by the training set. Furthermore, the method is significantly faster to train than deep learning approaches known in the art.

Further, by means of the invention, intervertebral discs can be successfully localized with a recall of 98.59%. Moreover, disc center positions are provided with a mean distance of 3.82±2.47 mm to the expert-annotated ground truth position.

1-12. (canceled)

13. A method for labeling one or more parts of a spine in a magnetic resonance image of a human or animal body, the method comprising the steps of:
transforming the magnetic resonance image including a first number of intensity levels into a target image including a second number of intensity levels, the second number of intensity levels being less than the first number of intensity levels, by applying a texture transformation to the magnetic resonance image, the texture transformation being obtained by matching a local model of the one or more parts of the spine to the spine in the magnetic resonance image, the local model being obtained by annotating training images showing one or more parts of a model spine, extracting landmarks from the annotated training images, and building the local model based on the extracted landmarks;
determining a position in each of the one or more parts of the spine in the target image, the position in each of the one or more parts of the spine in the target image corresponding to a position in the local model of the one or more parts of the spine; and
labeling the position of the one or more parts of the spine in the magnetic resonance image or the target image with anatomical labels.

14. The method according to claim 13, wherein the texture transformation applied to the magnetic resonance image corresponds to a transformation of training textures of the training images including the first number of intensity levels into target textures including the second number of intensity levels in terms of entropy.

15. The method according to claim 14, further comprising the step of optimizing the transformation of the training textures in terms of a probability of an occurrence of intensity values of the training textures.

16. The method according to claim 14, wherein the texture transformation applied to the magnetic resonance image corresponds to a transformation of the training textures for which an entropy-driven cost function is maximal or minimal.

17. The method according to claim 15, wherein the texture transformation applied to the magnetic resonance image corresponds to a transformation of the training textures for which an entropy-driven cost function is maximal or minimal.

18. The method according to claim 16, wherein the transformation of the training textures for which the entropy-driven cost function is maximal is determined iteratively.

19. The method according to claim 17, wherein the transformation of the training textures for which the entropy-driven cost function is maximal is determined iteratively.

20. The method according to claim 13, wherein the local model includes a three-disc model of a section of the spine including a middle disc, an adjacent upper disc, and an adjacent lower disc.

21. The method according to claim 13, wherein the local model is obtained by manually annotating the training images and/or automatically extracting the landmarks from the annotated training images.

22. The method according to claim 13, wherein the landmarks extracted from the annotated training images include sparse landmarks.

23. An apparatus for labeling one or more parts of a spine in a magnetic resonance image of a human or animal body, the apparatus comprising:
an image processor configured or programmed to:
transform the magnetic resonance image including a first number of intensity levels into a target image including a second number of intensity levels, the second number of intensity levels being less than the first number of intensity levels, by applying a texture transformation to the magnetic resonance image, the texture transformation being obtained by matching a local model of the one or more parts of the spine to the spine in the magnetic resonance image, the local model being obtained by annotating training images showing one or more parts of a model spine, extracting landmarks from the annotated training images, and building the local model based on the extracted landmarks;
determine a position in each of the one or more parts of the spine in the target image, the position in each of the one or more parts of the spine in the target image corresponding to a position in the local model of the one or more parts of the spine; and
label the position of the one or more parts of the spine in the magnetic resonance image or the target image with anatomical labels.

24. A system for magnetic resonance imaging and spine labeling, the system comprising:
a magnetic resonance imaging apparatus that acquires a magnetic resonance image of at least a part of a human or animal body; and
an apparatus that labels one or more parts of a spine in the magnetic resonance image according to the method of claim 21.
